(19) United States
(12) Patent Application Publication
(10) Pub. No.: US 2017/0372443 A1
(43) Pub. Date: Dec. 28, 2017

(54) METHOD AND APPARATUS FOR INFORMATION ANALYSIS

(71) Applicant: FUJITSU LIMITED, Kawasaki-shi (JP)

(72) Inventor: Tadaaki KATSUDA, Bunkyo (JP)

(73) Assignee: FUJITSU LIMITED, Kawasaki-shi (JP)

(21) Appl. No.: 15/698,129

(22) Filed: Sep. 7, 2017

Related U.S. Application Data
(63) Continuation of application No. PCT/JP2015/057651, filed on Mar. 16, 2015.

(51) Int. Cl. G06Q 50/24; G06F 19/00

(52) U.S. Cl. CPC G06Q 50/24; G06F 19/322

(57) ABSTRACT

A storing unit stores therein a plurality of patient information records corresponding one-to-one to a plurality of patients. A searching unit identifies, amongst the plurality of patient information records, one or more second patient information records resembling a first patient information record corresponding to a particular patient. An output processing unit outputs, based on the plurality of patient information records, a first plotted line representing medical condition changes over time in a first patient group that corresponds to the second patient information records and a second plotted line representing the medical condition changes over time in a second patient group that corresponds to the plurality of patient information records other than the second patient information records.

### CROSS-REFERENCE TO RELATED APPLICATION

This application is a continuation application of International Application PCT/JP2015/057651 filed on Mar. 16, 2015 which designated the U.S., the entire contents of which are incorporated herein by reference.

### FIELD

The embodiments discussed herein are related to a method and apparatus for information analysis.

### BACKGROUND

The study of the use of databases in the field of medicine has advanced in recent years. For example, several studies have been conducted on searching for patients who have similar patient information (referred to as “similar patients”) to that of a particular patient by use of a database which registers a large amount of patient information including test results and diagnostic outcomes of individual patients. The retrieval of the similar patients is expected to support various medical actions and treatment for the particular patient, for example, an assessment of the risk of disease recurrence and a decision on the course of appropriate treatment. In addition, databases, in which studies have advanced, are, for example, integrated disease omics databases which are integrations of clinicopathologic information and diagnostic imaging data of individual patients and genome/omics information on lesion sites and so on.

There is a proposed technique for displaying a graph representing changes in survival rate over time, which is an example of a technology for graphically displaying patient information for the purpose of therapeutic evaluation. As another example, there is a proposed technique for displaying a graph representing past test results of a plurality of patients in chronological order starting with the first day of medication.

Please see, for example, Japanese National Publication of International Patent Application No. 2005-501625 and Japanese Laid-open Patent Publication No. 2014-71592.

However, the use of database searching described above has been limited to allowing the user to refer to retrieved information on similar patients. Thus, effective use of database searching has yet to be established for deciding on a course of treatment for a particular patient.

### SUMMARY

According to an aspect, there is provided a non-transitory computer-readable storage medium storing a computer program that causes a computer to perform a procedure including: identifying, amongst a plurality of patient information records corresponding one-to-one to a plurality of patients and stored in a memory, one or more second patient information records each resembling a first patient information record corresponding to a particular patient; and outputting, based on the plurality of patient information records, a first plotted line representing medical condition changes over time in a first patient group that corresponds to the second patient information records and a second plotted line representing the medical condition changes over time in a second patient group that corresponds to remaining patient information records, the remaining patient information records being the plurality of patient information records other than the second patient information records.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a configuration and operation example of an information analysis device according to a first embodiment;

FIG. 2 illustrates a configuration example of an information processing system according to a second embodiment;

FIG. 3 illustrates an example of a hardware configuration of a server;

FIG. 4 is a block diagram illustrating a configuration example of processing functions of the server;

FIG. 5 illustrates an example of a patient database;

FIG. 6 illustrates an example of relevant item tables;

FIG. 7 is a flowchart illustrating an example of a process of creating the relevant item tables;

FIG. 8 illustrates an example of an analytical technique table;

FIG. 9 is a flowchart illustrating an example of a two-sample test process;

FIG. 10 is a flowchart illustrating an example of a multiple-sample test process;

FIG. 11 is a flowchart illustrating an example of a correlation analysis process;

FIG. 12 is a first flowchart illustrating an example of an analysis process;

FIG. 13 illustrates an example of an item input screen to designate an item;

FIG. 14 illustrates an example of a patient input screen to designate a patient;

FIG. 15 illustrates an example of a similar patient table;

FIG. 16 illustrates an example of an analysis item table;

FIG. 17 is a second flowchart illustrating the example of the analysis process;

FIG. 18 illustrates an example of a clinical condition progression graph created in step S43;

FIG. 19 illustrates an example of data calculated in step S44;

FIG. 20 illustrates an example of a clinical condition progression graph created in step S48; and

FIG. 21 illustrates an example of data calculated in step S49.

### DESCRIPTION OF EMBODIMENTS

Several embodiments will be described below with reference to the accompanying drawings, wherein like reference numerals refer to like elements throughout.

### (a) First Embodiment

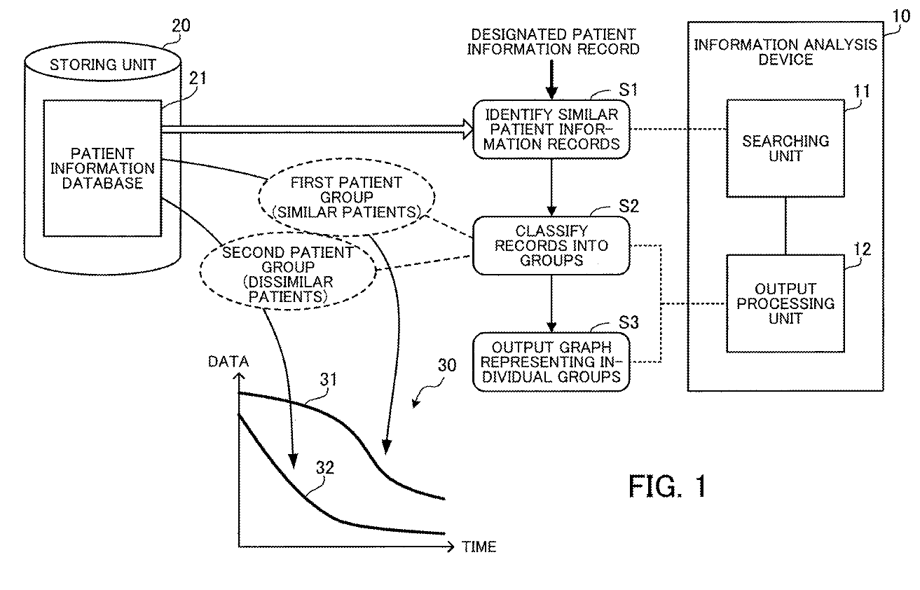

FIG. 1 illustrates a configuration and operation example of an information analysis device according to a first embodiment. An information analysis device 10 of FIG. 1 is a device for analyzing a plurality of patient information records stored in a storing unit 20, and is implemented, for example, as a computer. The patient information records targeted for analysis correspond one-to-one to individual patients. Each of the patient information records registers therein data entries under a plurality of items, associated with the corresponding patient.

Assume in the example of FIG. 1 that the analysis-target patient information records are registered in a patient information database 21. The storing unit 20 storing therein the patient information database 21 may be provided internally or externally to the information analysis device 10. The storing unit 20 is implemented as a volatile storage device such as random access memory (RAM), or a non-volatile storage device such as a hard disk drive (HDD).

The information analysis device 10 includes a searching unit 11 and an output processing unit 12. Processes carried out by the searching unit 11 and the output processing unit 12 are implemented, for example, by a processor of the information analysis device 10 executing a predetermined program. The processes of the searching unit 11 and the output processing unit 12 are described below according to the step numbers in FIG. 1. Upon receiving designation of a patient information record (hereinafter referred to as the “designated patient information record”) to be a search key, the searching unit 11 identifies, amongst patient information records included in the patient information database 21, similar patient information records that resemble the designated patient information record (step S1). In this regard, it is preferable to identify a plurality of similar patient information records.

The output processing unit 12 performs the following processing based on the patient information records included in the patient information database 21. The output processing unit 12 classifies patients registered in the patient information database 21 into a first patient group of patients corresponding to the similar patient information records (“similar patients”) identified by the searching unit 11 and a second patient group of the remaining patients (“dissimilar patients”) (step S2). The output processing unit 12 creates a graph representing medical condition changes over time in each of the first patient group and the second patient group and outputs the created graph (step S3). In the example of FIG. 1, a graph 30 is created in which curves 31 and 32 associated with the first and second patient groups, respectively, are plotted as curves representing changes in data entries associated with a medical condition.

Note that the graph representing medical condition changes is created for example based on, amongst data entries registered in the patient information database 21, data entries each indicating an amount of time taken for a patient in each patient group to enter a particular state following a starting point, such as the start of treatment. In this case, each curve in the graph indicates, for example, the proportion of patients having, or having not, entered the particular state to the total number of patients in the corresponding patient group. As another example, the graph representing medical condition changes may be created based on, amongst the data entries registered in the patient information database 21, test data entries measured at individual discrete time points in chronological order. In this case, each curve in the graph indicates, for example, calculation results obtained by performing a predetermined calculation using test data entries of individual patients in the corresponding patient group, such as average values of test data entries of the individual patients of the patient group.

According to the processing described above, the user is able to check, on the graph, the changes in the medical conditions associated with the similar patients and those associated with the dissimilar patients. Herewith, the user is provided with useful information for deciding on a course of treatment for a particular patient corresponding to the designated patient information record. For example, the user is able to determine whether the prognosis of the particular patient resembling the similar patients is good or bad by making a comparative review of the changes in the medical conditions associated with the similar patients and those associated with the dissimilar patients.

For example, by checking a graph only representing the changes in the medical conditions associated with the similar patients, the user is able to predict changes in the medical condition of the particular patient; however, the user is not able to determine whether the changes are good or bad. On the other hand, by checking a graph representing the changes in the medical conditions associated with the dissimilar patients in addition to those associated with the similar patients, the user is able to determine whether the changes in the medical conditions associated with the similar patients are good or not compared to the changes in the medical conditions associated with the dissimilar patients. This allows the user to determine whether the prognosis of the particular patient resembling the similar patients is good.

As a result, the user is able to make more active use of the determination results to decide a course of treatment for the particular patient. For example, the user is able to determine whether to actively administer a treatment to the particular patient in order to reduce the risk of later developing a specific medical condition. Alternatively, the user is able to review a subsequent course of treatment by determining whether a treatment administered to the particular patient is appropriate.

### (b) Second Embodiment

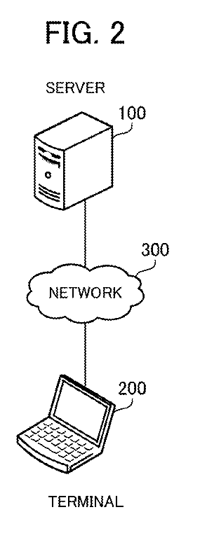

FIG. 2 illustrates a configuration example of an information processing system according to a second embodiment. The information processing system of FIG. 2 includes a server 100 and a terminal 200. The server 100 and the terminal 200 are connected to each other via a network 300. The network 300 may be a local area network (LAN), or a broad area network such as a wide area network (WAN) or the Internet.

The server 100 stores therein a patient database registering a plurality of patient information records. Each of the patient information records includes information entries of a plurality of items, associated with a patient. For example, information entries of the following items are included in each patient information record: attribute information, such as the gender of the patient; diagnostic outcomes of the patient; test results of the patient; administration of a treatment modality or not; and a state of the patient (medical condition) and a period for the patient to enter the state. Note that the patient database registers, at least, information on patients with diseases, or symptoms, mutually related to each other, for example. For example, the patient database registers information on patients with diseases of a particular part of the body or patients with diseases having a particular name.

In response to a retrieval request from the terminal 200, the server 100 searches the patient database for patients with patient information records the content of which is similar (the patients are hereinafter sometimes referred to as “similar patients”) to that of the patient information record of a particular patient, and transmits the retrieved results to the terminal 200. The search is sometimes referred to as a “similar case search”.

The server 100 has a function of retrieving similar patients based on information entries registered under particular items within the patient information records of the patient database. As the particular items, one or more items having relationships with an item designated through an input on the terminal 200 are selected. The server 100 also has a function of analyzing patient information records of the retrieved similar patients and transmitting results of the analysis to the terminal 200. For example, as the results of the analysis, a graph representing data transitions and information on evaluation results of the effectiveness of administered treatments (prognosis prediction results) is created.

The terminal 200 is a client computer used by the user. A medical doctor is a potential user of the terminal 200. It is conceivable that a medical doctor uses the terminal 200, for example, to reference information of different patients whose medical conditions and test results resemble those of a patient assigned to the doctor in order to predict the future medical condition of the patient or decide on a course of treatment for the patient.

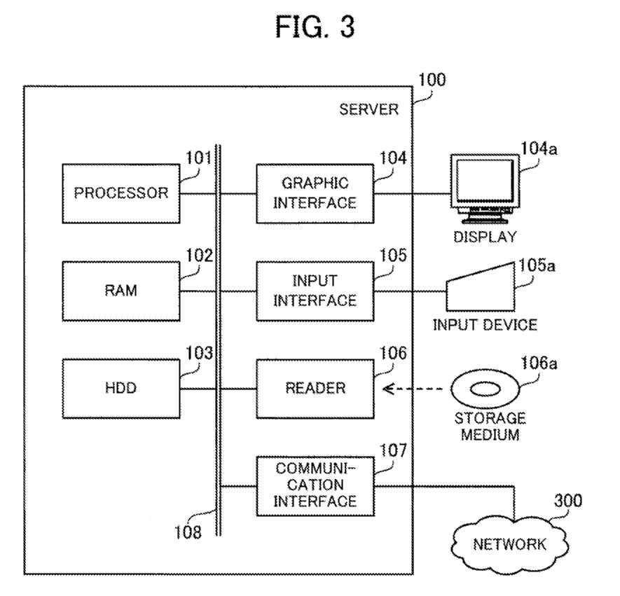

FIG. 3 illustrates an example of a hardware configuration of a server. The server 100 is implemented, for example, as a computer illustrated in FIG. 3. Overall control of the server 100 is exercised by a processor 101. The processor 101 may be a multi-processor. The processor 101 is, for example, a central processing unit (CPU), a micro processing unit (MPU), a digital signal processor (DSP), an application specific integrated circuit (ASIC), a programmable logic device (PLD), or a combination of two or more of these. To the processor 101, random access memory (RAM) 102 and a plurality of peripherals are connected via a bus 108.

The RAM 102 is used as a main storage device of the server 100. The RAM 102 temporarily stores at least part of an operating system (OS) program and application programs to be executed by the processor 101. The RAM 102 also stores therein various types of data to be used by the processor 101 for its processing.

The peripherals connected to the bus 108 include a hard disk drive (HDD) 103, a graphic interface 104, an input interface 105, a reader 106, and a communication interface 107. The HDD 103 is used as a secondary storage device of the server 100. The HDD 103 stores therein the OS program, application programs, and various types of data. Note that a different type of non-volatile storage device, such as a solid state drive (SSD), may be used as a secondary storage device in place of the HDD 103. To the graphic interface 104, a display 104a is connected. According to an instruction from the processor 101, the graphic interface 104 displays an image on the display 104a. A cathode ray tube (CRT) display or a liquid crystal display, for example, may be used as the display 104a.

To the input interface 105, an input device 105a is connected. The input interface 105 transmits signals output from the input device 105a to the processor 101. The input device 105a is, for example, a keyboard or a pointing device. Examples of the pointing device include a mouse, a touch panel, a tablet, a touch-pad, and a track ball.

Into the reader 106, a portable storage medium 106a is loaded. The reader 106 reads data recorded on the storage medium 106a and transmits the read data to the processor 101. The storage medium 106a may be an optical disk, a magneto optical disk, or semiconductor memory, for example.

The communication interface 107 transmits and receives data to and from a different device, for example, the terminal 200 via the network 300.

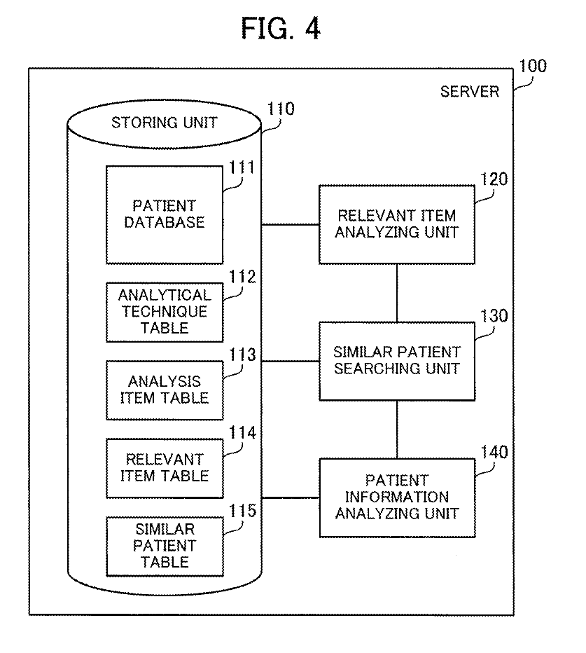

The hardware configuration described above achieves processing functions of the server 100. Note that the terminal 200 may also be implemented as a computer, such as the one illustrated in FIG. 3. FIG. 4 is a block diagram illustrating a configuration example of processing functions of a server. The server 100 includes a storing unit 110, a relevant item analyzing unit 120, a similar patient searching unit 130, and a patient information analyzing unit 140. The storing unit 110 is implemented using a storage area secured in, for example, the RAM 102 or the HDD 103. Processing of the relevant item analyzing unit 120, the similar patient searching unit 130, and the patient information analyzing unit 140 are implemented, for example, by the processor 101 executing a predetermined program.

The storing unit 110 includes a patient database 111, an analytical technique table 112, an analysis item table 113, a relevant item table 114, and a similar patient table 115.

The patient database 111, the analytical technique table 112, and the analysis item table 113 are prepared in advance before processing carried out by the relevant item analyzing unit 120, the similar patient searching unit 130, and the patient information analyzing unit 140. For this reason, the patient database 111, the analytical technique table 112, and the analysis item table 113 are preferably stored in a non-volatile storage device.

The patient database 111 registers therein patient information records of a large number of patients. As described above, each patient information record includes information entries under a plurality of items, associated with a corresponding patient. The analytical technique table 112 registers therein information on mappings between the items of the patient database 111 and analytical techniques implemented by the relevant item analyzing unit 120. The analysis item table 113 registers therein information on mappings among items indicating patient states, items each registering time information associated with a corresponding patient state, and analytical techniques performed by the patient information analyzing unit 140.

The relevant item table 114 is created by the relevant item analyzing unit 120. The relevant item table 114 registers “relevance indexes” each indicating the degree of relevance of one of the items of the patient database 111 to a different item thereof. As the relevance indexes, p-values and correlation values are used, for example. The similar patient table 115 is created by the similar patient searching unit 130. The similar patient table 115 registers therein degrees of similarity between the patient information record of a patient designated by the terminal 200 to the patient information records of other patients. Note that the relevant item table 114 is created for each key item, as described later.

The relevant item analyzing unit 120 performs the following processing on the items included in the patient database 111. That is, with respect to each item, the relevant item analyzing unit 120 calculates a relevance index indicating the degree of relevance between the item and each of the remaining items based on information entries registered under the items. The relevant item analyzing unit 120 registers the calculated individual relevance indexes in the relevant item table 114.

In addition, the relevant item analyzing unit 120 identifies, based on the relevant item table 114, “relevant items” having relationships with a “designated item” named by the terminal 200. Each of such relevant items is, amongst items other than the designated item, an item determined to have a strong relationship with the designated item by comparing its relevance index calculated against the designated item with a predetermined threshold.

The similar patient searching unit 130 performs the following processing on the patient information records registered in the patient database 111. The similar patient searching unit 130 receives designation of a patient from the terminal 200. Note that the patient designated by the terminal 200 is hereinafter sometimes referred to as “designated patient”. In this embodiment, the designated patient is selected amongst patients whose patient information records are registered in the patient database 111. The similar patient searching unit 130 calculates the degree of similarity of the patient information record of the designated patient to the patient information record of each of the remaining patients. In the calculation of the degree of similarity, items for comparison are limited to the designated item and its relevant items. The relevant item analyzing unit 120 registers the degree of similarity calculated for each of the other patients in the similar patient table 115, and also identifies patients whose degree of similarity is higher than a threshold as “similar patients”. The similar patient searching unit 130 transmits, to the terminal 200, at least either one of the similar patient table 115 and the similar patients.

The above-described processing of the relevant item analyzing unit 120 and the similar patient searching unit 130 allows search targets in searching similar patients to be narrowed down to information entries registered under relevant items having strong relationships with the item designated by the terminal 200. Herewith, similarity search is performed only within information likely to be desired by the user of the terminal 200 amongst all information registered in the patient database 111. This increases the chance of similar patients, useful for the user, to be retrieved.

The patient information analyzing unit 140 analyzes the patient information records of the similar patients retrieved by the similar patient searching unit 130 and transmits results of the analysis to the terminal 200. Specifically, the patient information analyzing unit 140 performs the following processing.

The patient information analyzing unit 140 classifies patients registered in the patient database 111 into a group of similar patients and a group of others (i.e., a group of dissimilar patients). Based on information entries on the time period associated with medical condition changes (hereinafter simply referred to as “time-to-change information entries”), registered under a particular item, the patient information analyzing unit 140 creates a graph representing the medical condition changes over time in each of the similar and dissimilar patient groups. The patient information analyzing unit 140 then transmits the created graph to the terminal 200. In addition, based on the time-to-change information entries corresponding to the similar patient group and those corresponding to the dissimilar patient group, the patient information analyzing unit 140 predicts the progression of a clinical condition (i.e., the prognosis) of the designated patient.

Then, the patient information analyzing unit 140 further classifies the similar patients into a plurality of groups according to administered treatment modalities, and creates a graph representing the medical condition changes in patients over time, such as the one described above, with respect to each of the groups. The patient information analyzing unit 140 then transmits the created graph to the terminal 200. In addition, based on the time-to-change information entries corresponding to each of the treatment modality groups, the patient information analyzing unit 140 determines an optimal treatment modality for the designated patient.

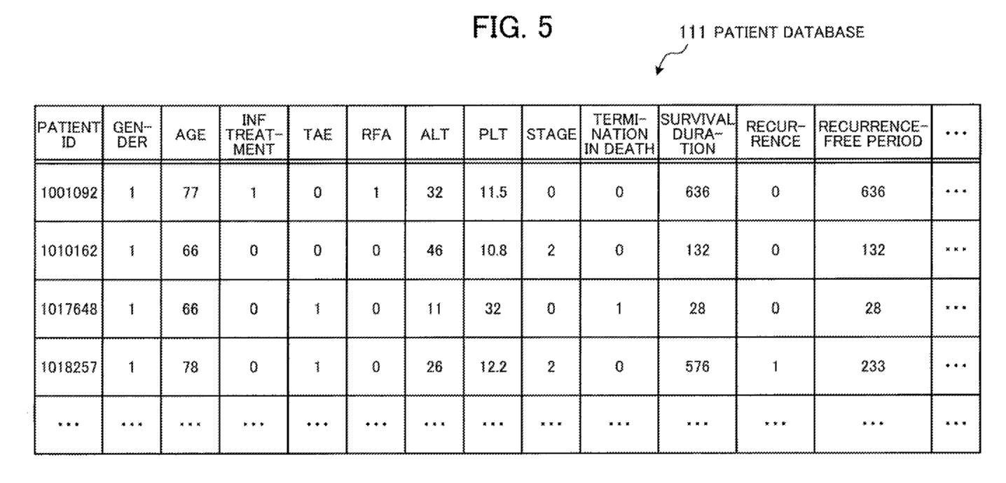

FIG. 5 illustrates an example of a patient database. The patient database 111 is stored in the storing unit 110. The patient database 111 includes, for example, the following items: patient identifier (ID); gender; age; interferon (INF) treatment; transcatheter arterial embolization (TAE); radiofrequency ablation (RFA); alanine aminotransferase (ALT); platelet (PLT); stage; termination in death; survival duration; recurrence; and recurrence-free period. A record corresponding to one patient identifier in the patient database 111 is a patient information record of a patient corresponding to the patient identifier. Assume in this embodiment that information on patients with liver disorders (hepatitis and liver cancer), for example, is registered in the patient database 111.

Each field under the item “patient identifier” contains the information used to identify a patient. Each field under the item “gender” contains the information for identifying the gender of the corresponding patient, i.e., either “1” indicating male or “0” indicating female. Each field under the item “age” contains a number indicating the age of the corresponding patient.

Each field under the item “INF treatment” contains information indicating whether the corresponding patient has undergone INF treatment, which is one of treatment modalities for hepatitis. Specifically, each field contains either “1” indicating that INF treatment has been administered or “0” indicating no INF treatment has been administered. Each field under the item “TAE” contains information indicating whether the corresponding patient has undergone TAE, which is one of treatment modalities for liver cancer. Specifically, each field contains either “1” indicating that TAE has been administered or “0” indicating no TAE has been administered. Each field under the item “RFA” contains information indicating whether the corresponding patient has undergone RFA, which is one of treatment modalities for liver cancer. Specifically, each field contains either “1” indicating that RFA has been administered or “0” indicating no RFA has been administered.

Each field under the item “ALT” contains a test value of ALT. Each field under the item “PLT” contains a test value of PLT. Each field under the item “stage” contains information indicating the stage of progression of a predetermined type of cancer. Specifically, each field contains one of 0 to 4, for example. A larger number indicates a higher stage of cancer progression.

Each field under the item “termination in death” contains information indicating whether the corresponding patient progressed to death. Specifically, each field contains either “1” indicating that the patient progressed to death or “0” indicating that the patient is still alive. Each field under the item “survival duration” contains information indicating survival duration since the start of treatment. Each field under the item “recurrence” contains information indicating whether the corresponding patient has experienced a recurrence. Specifically, each field contains either “1” indicating that the patient has experienced a recurrence or “0” indicating that the patient has experienced no recurrence. Each field under the item “recurrence-free period” contains a number indicating the period of time with no recurrence since the start of treatment.

In the example of FIG. 5 above, the items “gender” and “age” are examples of patient attribute information. The items “INF treatment”, “TAE”, and “RFA” are examples of information indicating whether a treatment modality has been administered to a patient. The items “ALT” and “PLT” are examples of a test result of a patient. The item “stage” is an example of information indicating a patient state in a phased manner. The items “termination in death” and “recurrence” are examples of information indicating whether a patient has entered a certain state. As for each of the items “termination in death” and “recurrence”, the patient state is classified into two phases to indicate at which clinical phase the patient is at the moment. Therefore, the items “termination in death” and “recurrence” may also be considered as examples of information indicating a patient state in a phased manner, as with the item “stage”. In addition, the items “stage”, “termination in death”, and “recurrence” may also be considered as examples of a diagnostic outcome of a patient. The items “survival duration” and “recurrence-free period” are examples of information indicating an amount of time taken for a patient to enter a certain state.

The patient database 111 may also register therein an item “gene expression amount in a lesion site”, which is an example of a test result of a patient. The gene expression amount is registered, for example, with respect to each DNA probe. Further, the patient database 111 may also register therein an item “image (or a link to the image)” of X-ray, magnetic resonance imaging (MRI), or the like, which is an example of a test result of a patient.

Next described are details of processing performed by the server 100. The processing of the server 100 is broadly divided into a process of creating the relevant item table 114 by the relevant item analyzing unit 120 and an analysis process according to an instruction from the user. The process of creating the relevant item table 114 by the relevant item analyzing unit 120 is described first. The creating process is performed as preprocessing before the analysis process.

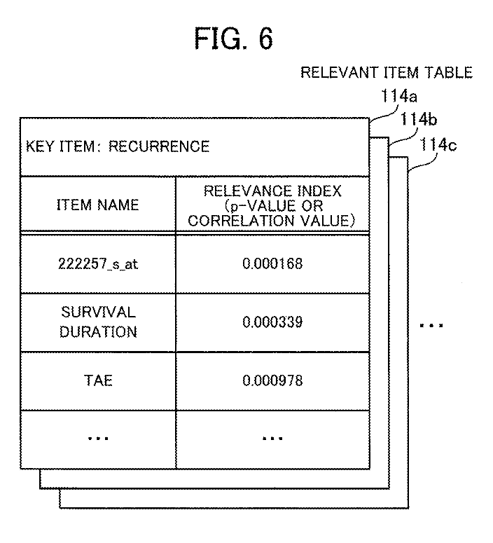

FIG. 6 illustrates an example of relevant item tables. Relevant item tables 114a, 114b, 114c, and so on correspond one-to-one to items each selectable from the terminal 200 as a designated item. The items corresponding one-to-one to the relevant item tables 114a, 114b, 114c, and so on are hereinafter referred to as “key items”. In the case where all items of the patient database 111 are selectable as a designated item, a relevant item table is created for each of all the items. In each of the relevant item tables 114a, 114b, 114c, and so on, a relevance index value is registered in association with, amongst the items included in the patient database 111, each item other than the corresponding key item. A p-value or correlation value is registered as the relevance index, as described above. Note that, hereinafter, the term “relevant item table 114” is used to refer to any one of the relevant item tables 114a, 114b, 114c, and so on.

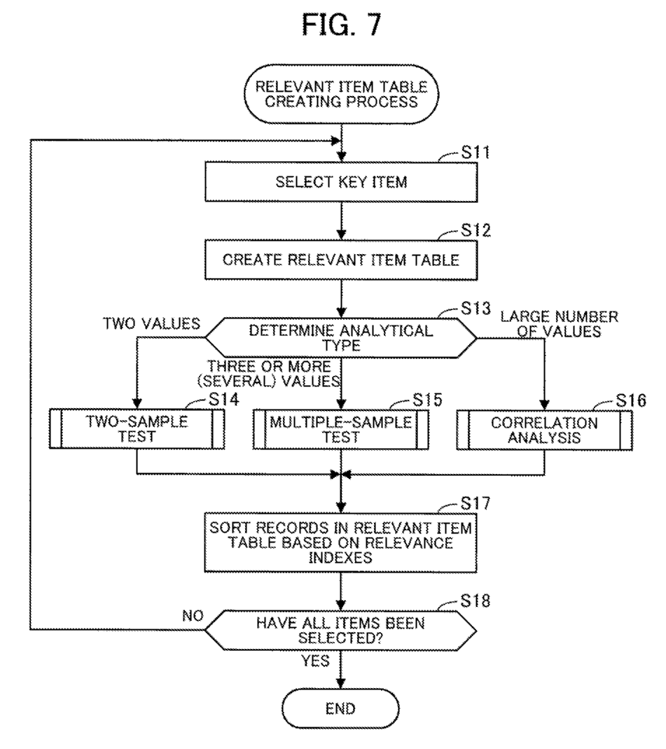

FIG. 7 is a flowchart illustrating an example of a process of creating relevant item tables.

[Step S11] Amongst the items in the patient database 111, the relevant item analyzing unit 120 selects, as a key item, one item selectable from the terminal 200 as a designated item.

[Step S12] The relevant item analyzing unit 120 creates the relevant item table 114 corresponding to the selected key item.

[Step S13] The relevant item analyzing unit 120 determines an analytical type corresponding to the item name of the key item. The analytical type indicates the type of an optimal analytical method associated with each item, and takes one of the following method types according to this embodiment: a two-sample test; a multiple-sample test; and a correlation analysis.

When the selected key item may take on two values “0” and “1”, the relevant item analyzing unit 120 determines a two-sample test to be suited, and then moves to step S14. When the selected key item may take on several values (i.e., the key item may take on three or more but a relatively small number of values), the relevant item analyzing unit 120 determines a multiple-sample test to be suited, and moves to step S15. When the selected key item may take on a large number of different values, the relevant item analyzing unit 120 determines a correlation analysis to be suited, and then moves to step S16.

In practice, in step S13, the relevant item analyzing unit 120 references the analytical technique table 112 to determine which one of the two-sample test, multiple-sample test, and correlation analysis is suited for the key item.

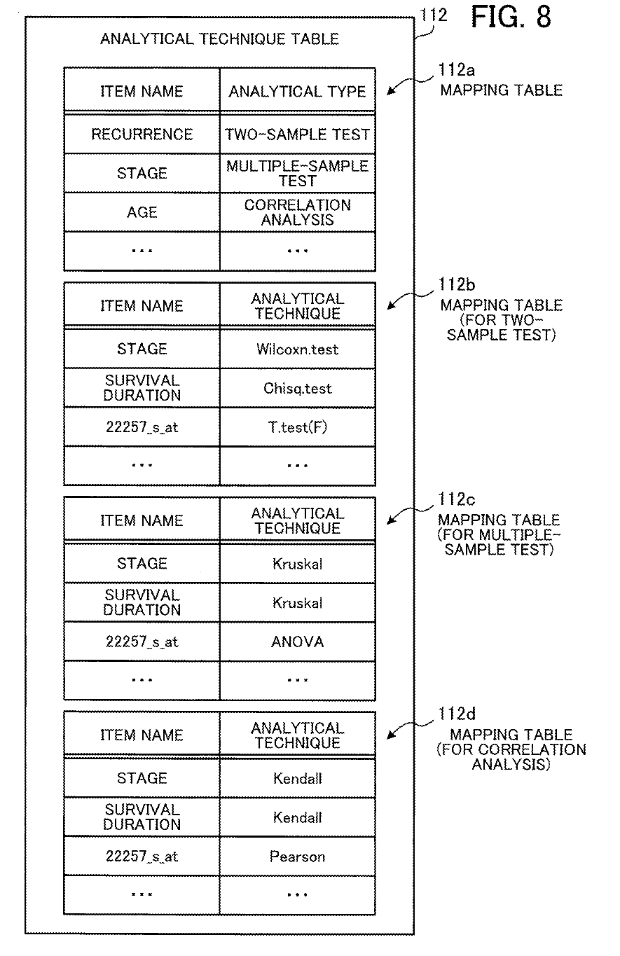

FIG. 8 illustrates an example of an analytical technique table. The analytical technique table 112 includes four types of mapping tables 112a to 112d.

The mapping table 112a is a table referenced in step S13 of FIG. 7. In the mapping table 112a, an analytical type is associated with each of the items included in the patient database 111. Specifically, the analytical type “two-sample test” is associated with each item which possibly takes on two values. Examples of such an item include ones indicating whether a patient has entered a particular state (e.g. “recurrence” and “termination in death”) and ones indicating whether a particular treatment modality has been administered (e.g. “INF treatment”, “TAE”, and “RFA”). In addition, the analytical type “multiple-sample test” is associated with each item which possibly takes on several values (three or more but a relatively small number of values). The item “stage” is an example of such. Further, the analytical type “correlation analysis” is associated with each item which possibly takes on a large number of different values. Examples of such an item include time information (e.g. “survival duration” and “recurrence-free period”) and test values (e.g. “ALT” and “PLT”).

The mapping table 112b is referenced in the two-sample test in step S14. The mapping table 112c is referenced in the multiple-sample test in step S15. The mapping table 112d is referenced in the correlation analysis in step S16. In each of the mapping tables 112b to 112d, an analytical technique is associated with each item of the patient database 111. The analytical types registered in the mapping table 112a are broad classifications of analytical methods, while the analytical techniques registered in the mapping tables 112b to 112d are classifications of specific methods for calculating relevance indexes. Examples of an analytical technique for each item are described later.

Now let us refer back to FIG. 7. In step S13, the relevant item analyzing unit 120 determines the analytical type corresponding to the designated item based on the mapping table 112a of the analytical technique table 112. If the corresponding analytical type is the two-sample test, the relevant item analyzing unit 120 moves to step S14. If the corresponding analytical type is the multiple-sample test, the relevant item analyzing unit 120 moves to step S15. If the corresponding analytical type is the correlation analysis, the relevant item analyzing unit 120 moves to step S16.

[Step S14] Using the two-sample test, the relevant item analyzing unit 120 calculates, with respect to each of the items included in the patient database 111 other than the key item (hereinafter simply referred to as “different items”), a relevance index representing the degree of relevance between the key item and the different item based on information entries registered under the key and different items. In this step, p-values are calculated as the relevance indexes. The relevant item analyzing unit 120 registers, in the relevant item table 114 created in step S12, each of the calculated p-values in association with the corresponding one of the different items.

[Step S15] Using the multiple-sample test, the relevant item analyzing unit 120 calculates, with respect to each of the different items, a relevance index representing the degree of relevance between the key item and the different item based on information entries registered under the key and different items. In this step, p-values are calculated as the relevance indexes. The relevant item analyzing unit 120 registers, in the relevant item table 114 created in step S12, each of the calculated p-values in association with the corresponding one of the different items.

[Step S16] Using the correlation analysis, the relevant item analyzing unit 120 calculates, with respect to each of the different items, a relevance index representing the degree of relevance between the key item and the different item based on information entries registered under the key and different items. In this step, correlation values are calculated as the relevance indexes. The relevant item analyzing unit 120 registers, in the relevant item table 114 created in step S12, each of the calculated correlation values in association with the corresponding one of the different items.

[Step S17] The relevant item analyzing unit 120 sorts records of the relevant item table 114 in such manner that a record with the relevance index indicating a higher relevance is located closer to the top of the relevant item table 114. In the case where p-values are registered as the relevance indexes, the records in the relevant item table 114 are sorted in such a manner that a record with a smaller p-value is located closer to the top. In the case where correlation values are registered as the relevance indexes, the records in the relevant item table 114 are sorted in such a manner that a record with a larger correlation value is located closer to the top.

[Step S18] The relevant item analyzing unit 120 determines whether each of all items selectable as a designated item has been selected as a key item. If there is one or more unselected items, the process moves to step S11. If all the items have been selected, the process ends.

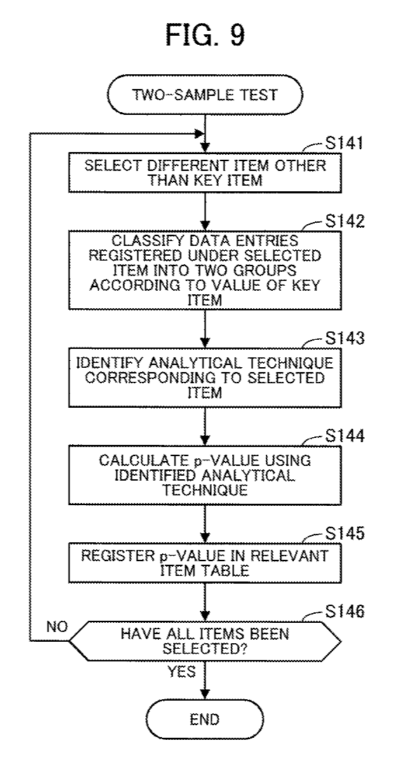

FIG. 9 is a flowchart illustrating an example of a two-sample test process. The process of FIG. 9 corresponds to step S14 of FIG. 7.

[Step S141] The relevant item analyzing unit 120 selects, amongst the items included in the patient database 111, one item other than the key item.

[Step S142] As for all data entries registered under the selected item, associated with the individual patient information records of the patient database 111, the relevant item analyzing unit 120 classifies the data entries into two groups according to the value (“0” or “1”) of the key item. Assume, for example, that the key item is “recurrence” and the item selected in step S141 is “stage” which possibly takes on four values. In this case, as for all values registered under the item “stage”, associated with the individual patient information records of the patient database 111, a value registered under the item “stage” of each patient information record having “0” in the item “recurrence” is placed into one group, while a value registered under the item “stage” of each patient information record having “1” in the item “recurrence” is placed into the other group.

[Step S143] The relevant item analyzing unit 120 references the mapping table 112b of the analytical technique table 112 to identify an analytical technique corresponding to the item selected in step S141.

[Step S144] The relevant item analyzing unit 120 calculates a relevance index using the identified analytical technique. In this step, a p-value is calculated which indicates how likely the null hypothesis that there is no association between the data of the two groups classified in step S142 is true. The lower the calculated p-value is, the higher the probability that there is association (significance) between the data of the two groups.

In step S143, based on the mapping table 112b, an optimal analytical technique is selected, corresponding to a combination of the key item and the item selected in step S141 (for brevity referred to as the “different item”). The following techniques are examples of such an optimal analytical technique. In the case where the different item possibly takes on two values (“0” and “1”), as with the item “termination in death”, Pearson's chi-square test or Fisher's exact test, for example, is employed. In the case where the different item possibly takes on several values (three or more but a relatively small number of values), as with the item “stage”, Mann-Whitney-Wilcoxon test is employed, for example. In the case where the different item possibly takes on a large number of values, as with time information (e.g. the item “survival duration”) and test values (e.g. the item “ALT”), Student's t-test or Welch's t-test, for example, is employed.

[Step S145] The relevant item analyzing unit 120 registers, in the relevant item table 114 corresponding to the key item, the item name of the item selected in step S141 and the p-value calculated in step S144 in association with each other. Note that in the case where there is no relevant item table 114 corresponding to the key item, the relevant item analyzing unit 120 creates the relevant item table 114 corresponding to the key item, and then carries out the above-described registration.

[Step S146] The relevant item analyzing unit 120 determines whether to have selected all the items other than the key item amongst the items included in the patient database 111. If there is one or more unselected items, the relevant item analyzing unit 120 moves to step S141. If all the items have been selected, the process ends.

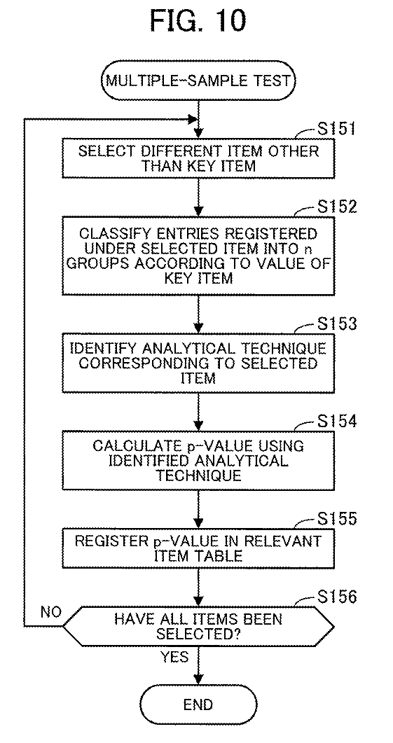

FIG. 10 is a flowchart illustrating an example of a multiple-sample test process. The process of FIG. 10 corresponds to step S15 of FIG. 7.

[Step S151] The relevant item analyzing unit 120 selects, amongst the items included in the patient database 111, one item other than the key item.

[Step S152] Assume that the key item possibly takes on n different values. As for all data entries registered under the selected item, associated with the individual patient information records of the patient database 111, the relevant item analyzing unit 120 classifies the data entries into n groups according to the value of the key item. Assume, for example, that the key item is “stage” which possibly takes on four values from “1” to “4” and the item selected in step S151 is “survival duration”. In this case, each of all values registered under the item “survival duration”, associated with the individual patient information records of the patient database 111, is classified according to the value of the item “stage” in the corresponding patient information record into one of the following groups: a group with “1” registered under the item “stage”; a group with “2” registered under the item “stage”; a group with “3” registered under the item “stage”; and a group with “4” registered under the item “stage”.

[Step S153] The relevant item analyzing unit 120 references the mapping table 112c of the analytical technique table 112 to identify an analytical technique corresponding to the item selected in step S151.

[Step S154] The relevant item analyzing unit 120 calculates a relevance index using the identified analytical technique. In this step, a p-value is calculated which indicates how likely the null hypothesis that there is no association among the data of the n groups classified in step S152 is true. The lower the calculated p-value is, the higher the probability that there is association (significance) among the data of the n groups.

In step S153, based on the mapping table 112c, an optimal analytical technique is selected, corresponding to a combination of the key item and the item selected in step S151 (for brevity referred to as the “different item”). The following techniques are examples of such an optimal analytical technique. In the case where the different item possibly takes on two values (“0” and “1”), as with the item “termination in death”, or several values (three or more but a relatively small number of values), as with the item “stage”, Kruskal-Wallis test is employed, for example. In the case where the different item possibly takes on a large number of values, as with time information (e.g. the item “survival duration”) and test values (e.g. the item “ALT”), analysis of variance (ANOVA) is employed, for example.

[Step S155] The relevant item analyzing unit 120 registers, in the relevant item table 114 corresponding to the key item, the item name of the item selected in step S151 and the p-value calculated in step S154 in association with each other. Note that in the case where there is no relevant item table 114 corresponding to the key item, the relevant item analyzing unit 120 creates the relevant item table 114 corresponding to the key item, and then carries out the above-described registration.

[Step S156] The relevant item analyzing unit 120 determines whether to have selected all the items other than the key item amongst the items included in the patient database 111. If there is one or more unselected items, the relevant item analyzing unit 120 moves to step S151. If all the items have been selected, the process ends.

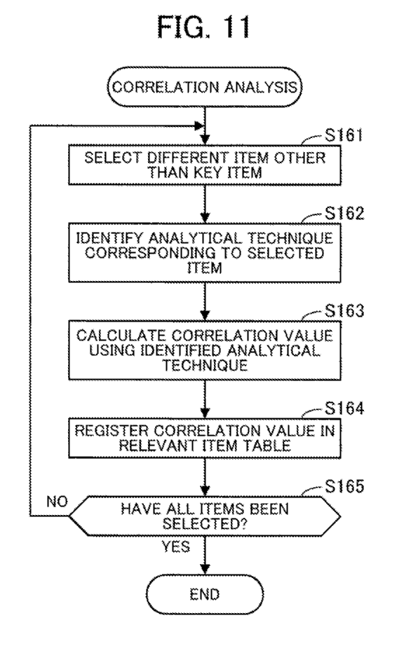

FIG. 11 is a flowchart illustrating an example of a correlation analysis process. The process of FIG. 11 corresponds to step S16 of FIG. 7.

[Step S161] The relevant item analyzing unit 120 selects, amongst the items included in the patient database 111, one item other than the key item.

[Step S162] The relevant item analyzing unit 120 references the mapping table 112d of the analytical technique table 112 to identify an analytical technique corresponding to the item selected in step S161.

[Step S163] The relevant item analyzing unit 120 calculates a relevance index using the identified analytical technique. In this step, a correlation value (correlation coefficient) is calculated which indicates the correlation between a group of data entries of all the patients registered under the key item and a group of data entries of all the patients registered under the item selected in step S161. The higher the calculated correlation value, the higher the probability that there is association (significance) between the values registered under the key item and those registered under the item selected in step S161.

In step S162, based on the mapping table 112d, an optimal analytical technique is selected, corresponding to a combination of the key item and the item selected in step S161 (for brevity referred to as the “different item”). The following techniques are examples of such an optimal analytical technique. In the case where the different item possibly takes on two values (“0” and “1”), as with the item “termination in death”, or several values (three or more but a relatively small number of values), as with the item “stage”, a technique for calculating Kendall's rank correlation coefficient or Spearman's rank correlation coefficient, for example, is employed. In the case where the different item possibly takes on a large number of values, as with time information (e.g. the item “survival duration”) and test values (e.g. the item “ALT”), a technique for calculating Pearson's product-moment correlation coefficient or maximal information coefficient (MIC), for example, is employed.

[Step S164] The relevant item analyzing unit 120 registers, in the relevant item table 114 corresponding to the key item, the item name of the item selected in step S161 and the correlation value calculated in step S163 in association with each other. Note that in the case where there is no relevant item table 114 corresponding to the key item, the relevant item analyzing unit 120 creates the relevant item table 114 corresponding to the key item, and then carries out the above-described registration.

[Step S165] The relevant item analyzing unit 120 determines whether to have selected all the items other than the key item amongst the items included in the patient database 111. If there is one or more unselected items, the relevant item analyzing unit 120 moves to step S161. If all the items have been selected, the process ends.

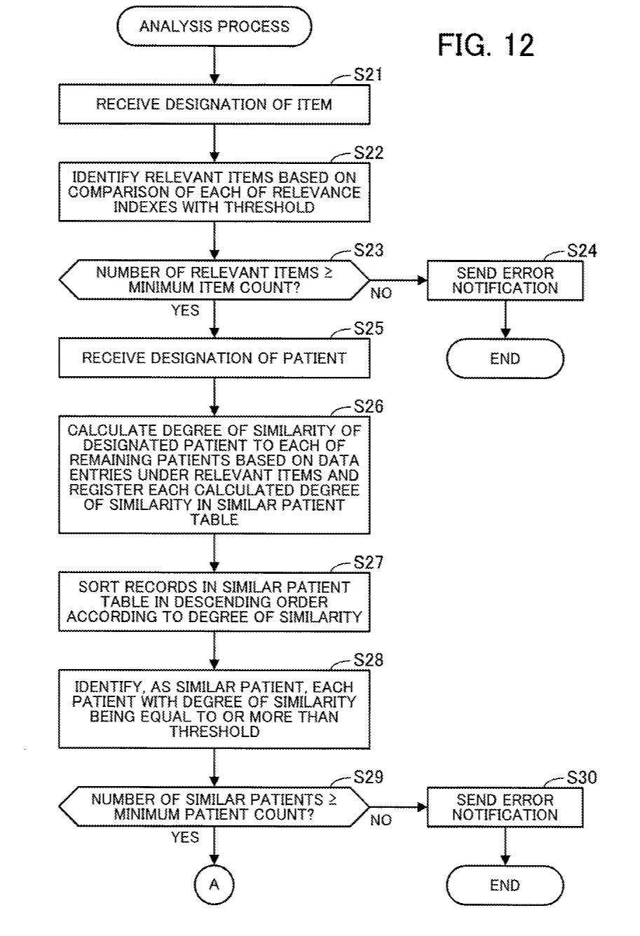

Next described is an analysis process according to an instruction from the user. FIG. 12 is a first flowchart illustrating an example of the analysis process.

[Step S21] The relevant item analyzing unit 120 receives designation of an item from the terminal 200. In addition, according to this embodiment, the relevant item analyzing unit 120 receives, from the terminal 200, input of various parameters used to identify relevant items.

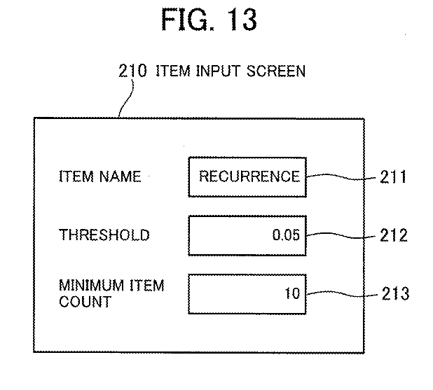

FIG. 13 illustrates an example of an item input screen to designate an item. The relevant item analyzing unit 120 receives input of a designated item by causing, for example, a display unit of the terminal 200 to display an item input screen 210 of FIG. 13. In an input field 211 on the item input screen 210, an item designated (designated item) amongst the items included in the patient database 111 is entered by a user's operation.

In addition, using the item input screen 210, the relevant item analyzing unit 120 may also receive input of various parameters used to identify relevant items. Input fields 212 and 213 of FIG. 13 are examples of a parameter input field. A threshold to determine whether each item is a relevant item based on a relevance index between items is entered in the input field 212. In the case where a higher relevance index indicates higher association, a corresponding item is determined to be a relevant item if the relevance index is equal to or more than the threshold. On the other hand, in the case where a lower relevance index indicates higher association, a corresponding item is determined to be a relevant item if the relevance index is equal to or less than the threshold. In the input field 213, the minimum item count is entered. If the number of relevant items identified by comparison of each calculated relevance index with the threshold is less than the minimum item count input in the input field 213, similarity search is not performed because retrieval accuracy is not guaranteed due to lack of relevant items to be used by the similar patient searching unit 130 for similarity search.

Now let us refer back to FIG. 12. In step S21, the relevant item analyzing unit 120 receives the item, threshold, and minimum item count entered on the item input screen 210 from the terminal 200.

[Step S22] The relevant item analyzing unit 120 references the relevant item table 114 whose key item is the designated item received in step S21. The relevant item analyzing unit 120 compares each of the relevance indexes registered in the relevant item table 114 with the threshold received in step S21, to thereby identify relevant items amongst the items registered in the relevant item table 114. In the case where the relevance indexes in the referenced relevant item table 114 are p-values, each item whose p-value is equal to or less than the threshold is identified as a relevant item. On the other hand, in the case where the relevance indexes in the referenced relevant item table 114 are correlation values, each item whose correlation value is equal to or more than the threshold is identified as a relevant item.

[Step S23] The relevant item analyzing unit 120 determines whether the number of relevant items identified in step S22 is equal to or more than the minimum item count received in step S21. If the number of relevant items is equal to or more than the minimum item count, the process moves to step S25. On the other hand, if the number of relevant items is less than the minimum item count, the process moves to step S24.

[Step S24] The relevant item analyzing unit 120 notifies the terminal 200 of the occurrence of an error and ends the process. This is because the number of relevant items to be used by the similar patient searching unit 130 for similarity search is too small to guarantee retrieval accuracy when the number of relevant items is less than the minimum item count.

[Step S25] The similar patient searching unit 130 receives designation of a patient from the terminal 200. In addition, the similar patient searching unit 130 also receives, from the terminal 200, input of various parameters used to search similar patients.

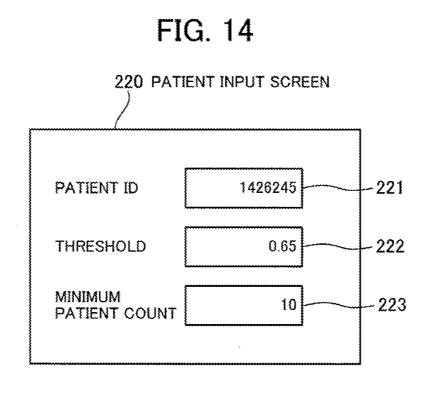

FIG. 14 illustrates an example of a patient input screen to designate a patient. The relevant item analyzing unit 120 receives input of a designated patient by causing, for example, the display unit of the terminal 200 to display a patient input screen 220 of FIG. 14. In an input field 221 on the patient input screen 220, the patient identifier of a patient designated (designated patient) amongst the patients registered in the patient database 111 is entered by a user's operation.

In addition, using the patient input screen 220, the similar patient searching unit 130 may also receive input of various parameters used to search similar patients. Input fields 222 and 223 of FIG. 14 are examples of a parameter input field. A threshold to determine whether each comparison target patient is a similar patient based on a calculated degree of similarity is entered in the input field 222. If the degree of similarity is equal to or more than the threshold, the comparison target patient is determined to be a similar patient resembling the designated patient. In the input field 223, the minimum patient count is entered. The minimum patient count is set for the following reason.

In a subsequent process performed by the patient information analyzing unit 140, the patient information records are classified into a group of similar patients and a group of remaining dissimilar patients, and graph making and analysis processing are carried out for each of the groups. In this regard, the number of identified similar patients being too small decreases the significance of the graph and accuracy of the analysis for the similar patient group. For this reason, if the number of identified similar patients is lower than the minimum patient count, the process of the patient information analyzing unit 140 is not performed.

Now let us refer back to FIG. 12. In step S25, the similar patient searching unit 130 receives the patient identifier, threshold, and the minimum patient count entered on the patient input screen 220 from the terminal 200.

[Step S26] The similar patient searching unit 130 calculates the degree of similarity of the patient information record of the designated patient to that of each of the remaining patients other than the designated patient by using only data entries registered under the designated item and its relevant items. The similar patient searching unit 130 registers, in the similar patient table 115, the degree of similarity calculated for each of the remaining patients.

In order to measure the degree of similarity, the following methods may be used, for example: Pearson's product-moment correlation coefficient; Kendall's rank correlation coefficient; Spearman's rank correlation coefficient; cosine similarity; and MIC. Alternatively, in step S26, the degree of similarity may be calculated using only data entries registered under the relevant items.

[Step S27] The similar patient searching unit 130 sorts records of the similar patient table 115 in such a manner that a record with a higher degree of similarity is located closer to the top of the similar patient table 115. Note that the similar patient searching unit 130 may transmit the sorted similar patient table 115 to the terminal 200.

[Step S28] Based on the similar patient table 115, the similar patient searching unit 130 identifies that each patient with the calculated degree of similarity being equal to or more than the threshold received in step S25 is a similar patient. The similar patient searching unit 130 transmits, for example, the patient identifier of each identified similar patient to the terminal 200. The user of the terminal 200 instructs, for example, the server 100 to search the patient database 111 using each of the transmitted patient identifiers as a search key, to thereby view the content of the patient information record corresponding to the patient identifier.

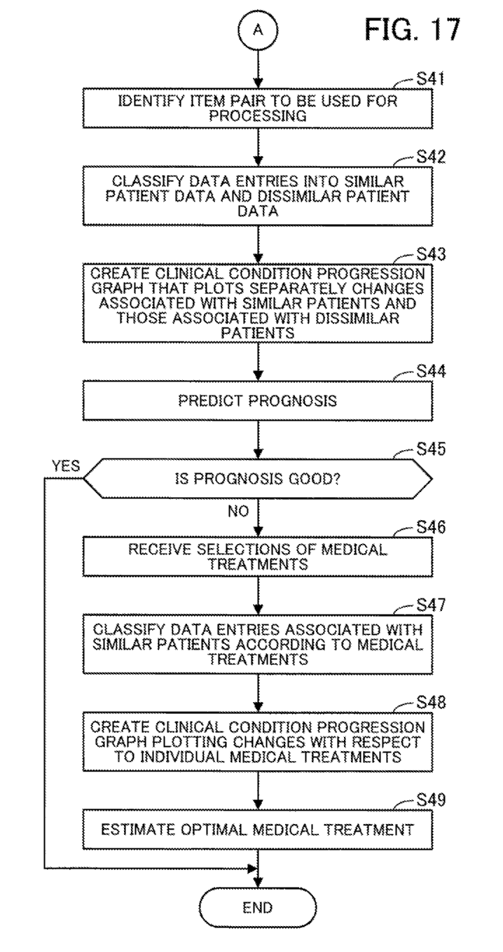

Note that, in step S28, the similar patient searching unit 130 may transmit, for example, the patient information records of the identified similar patients to the terminal 200. In this case, the content of the transmitted patient information records may only include data entries registered under the designated item and the relevant items.

[Step S29] The similar patient searching unit 130 determines whether the number of similar patients identified in step S28 is equal to or more than the minimum patient count received in step S25. If the number of similar patients is equal to or more than the minimum patient count, the process moves to step S41 of FIG. 17. On the other hand, if the number of similar patients is less than the minimum patient count, the process moves to step S30.

[Step S30] The similar patient searching unit 130 notifies the terminal 200 of the occurrence of an error and ends the process. This is because the number of similar patients being less than the minimum patient count decreases the significance of a graph to be created by the patient information analyzing unit 140 for the similar patient group and impairs the analysis accuracy of the similar patient group.

Note that, according to this embodiment, the relevant item table 114 for each key item is created in advance before the reception of the item designation from the user in step S21 of FIG. 12. However, alternatively, upon receiving designation of an item from the user in step S21, steps S12 to S17 of FIG. 7 may be carried out using the designated item as a key item to obtain relevance indexes, and then step S22 and the subsequent steps may be performed using the obtained relevance indexes.

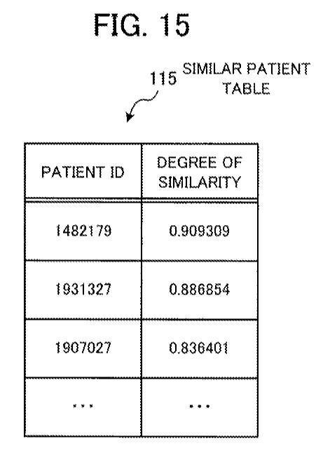

FIG. 15 illustrates an example of a similar patient table. The similar patient table 115 registers therein, with respect to each of the patient identifiers of the patients registered in the patient database 111, the degree of similarity calculated by the similar patient searching unit 130. In addition, in step S27 of FIG. 12, the records corresponding to the individual patient identifiers are eventually sorted in descending order according to the degree of similarity. For example, in the case where the similar patient table 115 is transmitted to the terminal 200, the user views the sorted similar patient table 115 to readily check patient identifiers of patients with a high degree of similarity and the degree of similarity calculated for each of these patients.

According to the above-described processes of the relevant item analyzing unit 120 and the similar patient searching unit 130, search targets in searching similar patients are narrowed down to information entries registered under the designated item named by the user and the relevant items having strong relationships with the designated item. Herewith, similarity search is performed only within information likely to be desired by the user of the terminal 200 amongst all the information in the patient database 111. This increases the chance of similar patients desired by the user to be retrieved, which in turn enhances usability of similarity search.

For example, in the case where, using a particular patient as a search key, the user (for example, a medical doctor) searches for patients whose patient information records resemble that of the patient, the key patient often has a disease of some sort or exhibits symptoms of some sort. Therefore, in searching for similar patients, it is often the case that the user desires to search for patients with a disease or symptoms similar to those of the key patient as similar patients.

However, inclusion of a larger number of items in the patient database 111 increases the percentage of data having little association with the disease or symptoms of the key patient. As a result, if the retrieval of similar patients is made by using data entries under all the items included in the patient database 111 as search targets, there is a high possibility of including patients not serving the above-described purposes of the user in identified similar patients. On the other hand, according to this embodiment, an item having strong relationships with the disease or symptoms of the key patient is designated by the user, and comparison targets in similarity search are narrowed down to the designated item and items having strong relationships with the designated item. This increases the likelihood of retrieving patients serving the purposes of the user as similar patients.

Because, in the similarity search, data to be compared is narrowed down and, therefore, the data quantity applied to the similarity calculation is reduced, the retrieval processing takes less time compared to the case of using all the items as comparison targets. In this regard, as in the example of FIG. 7, calculating in advance relevance indexes of each key item with respect to the individual remaining items before the reception of the item designation from the user (step S21 of FIG. 12) shortens the time needed to obtain search results after the user makes the item designation.

Next described is processing performed by the patient information analyzing unit 140. The processing of the patient information analyzing unit 140 uses, as analysis targets, data entries under items allowing the calculation of changes in the percentage of patients entering a particular state over time since the start of treatment amongst the data registered in the patient database 111. The analysis item table 113 referenced by the patient information analyzing unit 140 is described first. The analysis item table 113 is an example of information for mainly identifying items used in the above-mentioned processing of the patient information analyzing unit 140.

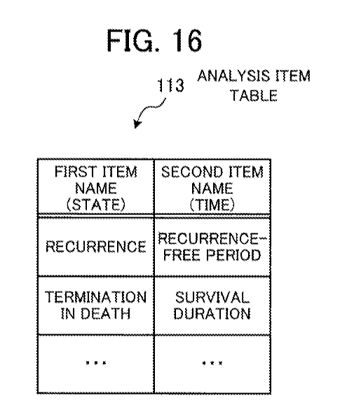

FIG. 16 illustrates an example of an analysis item table. Each record of the analysis item table 113 includes a first item name, a second item name, and an optimal analytical technique in association with one another. The first item name indicates identification information of a first item. The second item name indicates identification information of a second item. The optimal analytical technique is an analytical technique best suited for the combination of the first and second items.

The first item is, amongst the items included in the patient database 111, an item indicating whether a patient has entered a particular state. Examples of such an item include “recurrence” and “termination in death”. The second item is an item registering time information on the duration from the start of treatment until a patient entered the state of the first item. For example, in the case where the first item is “recurrence”, the second item is “recurrence-free period”. In the case where the first item is “termination in death”, the second item is “survival duration”.

The paired first and second items indicate data to be used in the analysis process performed by the patient information analyzing unit 140. The paired first and second items may enable the calculation of the period during which each corresponding patient has yet to enter the particular state since the start of treatment. Using data of such items, it is possible to calculate changes in the percentage of patients entering a particular state over time since the start of treatment, as described later.

FIG. 17 is a second flowchart illustrating the example of the analysis process.

[Step S41] The patient information analyzing unit 140 references the analysis item table 113 to identify a pair of the first and second items whose registered data entries are used in the following processing. In the case where an item indicating whether a patient has entered a particular state, such as the items “recurrence” and “termination in death”, has been named as the designated item, the patient information analyzing unit 140 sets the designated item as the first item and then identifies the second item associated with the designated item in the analysis item table 113. On the other hand, in the case where an item registering therein time information, such as the items “recurrence-free period” and “survival duration”, has been named as the designated item, the patient information analyzing unit 140 sets the designated item as the second item and then identifies the first item associated with the designated item in the analysis item table 113.

[Step S42] The patient information analyzing unit 140 classifies data entries registered under the paired first and second items identified in the step S41 within the patient database 111 into a data group of similar patients (the “similar patient data group”) and a data group of patients other than the similar patients (the “dissimilar patient data group”).

[Step S43] The patient information analyzing unit 140 creates a clinical condition progression graph which plots state transition changes associated with the similar patient data group and state transition changes associated with the dissimilar patient data group. The state transition changes represent changes over time in the percentage of patients entering a particular state corresponding to the first item identified in step S41. The state transition changes are calculated using, for example, the Kaplan-Meier method or Cutler-Ederer method.

The patient information analyzing unit 140 transmits the created clinical condition progression graph to the terminal 200. The transmitted clinical condition progression graph is presented on a display connected to the terminal 200.

[Step S44] Based on the similar patient data group, the patient information analyzing unit 140 predicts the prognosis of the designated patient. In the prognosis prediction, it is determined whether the prognosis is good, poor, or unknown. The patient information analyzing unit 140 transmits the prognosis prediction result to the terminal 200.

[Step S45] The patient information analyzing unit 140 determines whether the prognosis prediction result is good. If the prognosis prediction result is good, the process ends. If the prognosis prediction result is poor or unknown, the process moves to step S46.

[Step S46] The patient information analyzing unit 140 receives, from the terminal 200, selections of medical treatments according to a user's operation. In this step, a plurality of medical treatments are selected, which correspond to, amongst the items included in the patient database 111, items each indicating whether the corresponding medical treatment has been administered.

[Step S47] The patient information analyzing unit 140 classifies, amongst the data entries registered under the paired first and second items identified in the step S41, data entries associated with the similar patients according to the individual medical treatments received in step S46.

Assume, for example, that the items “recurrence” and “recurrence-free period” are identified in step S41 as the first and second items, respectively, and the items “RFA” and “TAE” are selected in step S46 as the treatment modalities. In this case, the patient information analyzing unit 140 classifies, amongst the data entries registered under the paired items “recurrence” and “recurrence-free period”, data entries associated with the similar patients into a group with “1” registered under the item “RFA” and a group with “1” registered under the item “TAE”. A value of “1” under the item “RFA” indicates that RFA has been administered while a value of “1” under the item “TAE” indicates that TAE has been administered. In addition, the patient information analyzing unit 140 may form a different group with “1” registered under both the items “RFA” and “TAE” amongst the data entries registered under the paired items “recurrence” and “recurrence-free period” and associated with the similar patients. Further, the patient information analyzing unit 140 may form a different group with “0” registered under both the items “RFA” and “TAE” amongst the data entries registered under the paired items “recurrence” and “recurrence-free period” and associated with the similar patients. Note that data entries of the same similar patients may belong to a plurality of groups.

[Step S48] The patient information analyzing unit 140 creates a clinical condition progression graph that plots state transition changes associated with each of the groups classified in step S47. Herewith, the graph is created, which represents at least state transition changes with respect to each of the administered medical treatments. The patient information analyzing unit 140 transmits the created clinical condition progression graph to the terminal 200. The transmitted clinical condition progression graph is presented on the display connected to the terminal 200.

[Step S49] Based on the data entries of the individual groups classified in step S47, the patient information analyzing unit 140 estimates which one of the medical treatments is best suited. The patient information analyzing unit 140 transmits, for example, information indicating a medical treatment estimated to be optimal to the terminal 200.

Note that, according to the process of FIG. 17, step S46 and the subsequent steps are performed only when the prognosis is not determined to be good in step S45; however, step S46 and the subsequent steps may be performed regardless of the result of the prognosis determination in step S45.

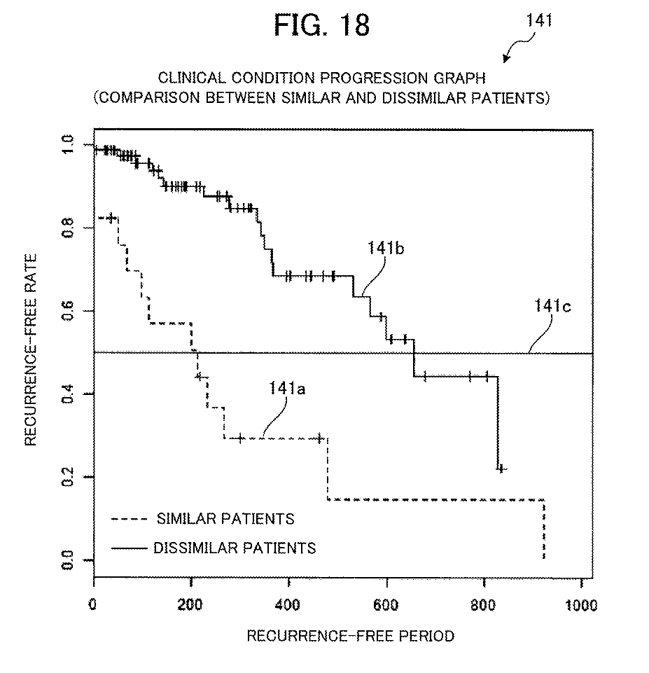

FIG. 18 illustrates an example of a clinical condition progression graph created in step S43. A clinical condition progression graph 141 of FIG. 18 represents an example where the time information item “recurrence-free period” has been selected (in step S41). In this case, the horizontal axis represents the recurrence-free period, and the vertical axis represents, for example, the recurrence-free rate. Such a clinical condition progression graph is created also when the item “recurrence” or “recurrence-free period” has been named as the designated item. In addition, the vertical axis of the clinical condition progression graph 141 may represent the recurrence rate instead.

In the clinical condition progression graph 141, a curve 141a representing state transition changes associated with the similar patient data group and a curve 141b representing state transition changes associated with the dissimilar patient data group are plotted as Kaplan-Meier curves. For example, the curve 141a representing state transition changes associated with the similar patient data group is created in the following manner.

The patient information analyzing unit 140 finds the number of similar patients being free of relapse at a given time when the recurrence-free period begins at the start of treatment (the “starting point”). The number of similar patients being free of relapse at the given time is obtained by adding together the number of similar patients having “0” in the item “recurrence” and the number of similar patients having “1” in the item “recurrence” but the time registered in the item “recurrence-free period” being longer than the time period from the starting point to the given time. The patient information analyzing unit 140 calculates the recurrence-free rate at the given time by dividing the number of similar patients being free of relapse obtained above by the total number of similar patients. The patient information analyzing unit 140 performs this calculation for each indicated time point to thereby create the curve 141a representing the state transition changes associated with the similar patient data group, as illustrated in FIG. 18. The curve 141b representing the state transition changes associated with the dissimilar patient data group is created by the same procedure described above using data of the dissimilar patients.

According to the clinical condition progression graph 141 of FIG. 18, it is understood that the dissimilar patients not resembling the designated patient generally tend to have longer period of time to recurrence from the start of treatment compared to the similar patients resembling the designated patient. In this case, the user is able to determine, for example, that the designated patient is at relatively high risk for recurrence. In addition, the user is able to use the clinical condition progression graph above to predict changes in symptoms of the designated patient and determine the propriety of a medical treatment administered to the designated patient.

Note that, for example, in the case where the time information item “survival duration” is selected in step S41, a graph with survival duration on the horizontal axis and survival rate on the vertical axis is created by the same procedure described above using data entries registered under the individual items “survival duration” and “termination in death”.

The clinical condition progression graph 141 described above represents, not only the state transition changes associated with the similar patients, but also the state transition changes associated with the remaining dissimilar patients as a comparison target. Thus, by being provided with the comparison target for the state transition changes associated with the similar patients, the user is able to determine whether the progress of medical conditions of the similar patients was good. As a result, the user is able to estimate the prognosis of the designated patient whose patient information record resembles those of the similar patients. Herewith, the user is provided with useful information for supporting medical treatment of the designated patient, for example, determination of whether a treatment administered to the designated patient is appropriate or a decision on a future course of treatment.

In addition, the similar patients are retrieved using only the designated item named by the user and relevant items having strong relationships with the designated item as comparison targets, and are therefore likely to serve the user's purpose of searching. The clinical condition progression graph 141 is created based on such search results, which enhances usability of the clinical condition progression graph 141 for supporting medical treatment of the designated patient. For example, the user's determination accuracy based on the clinical condition progression graph 141 is improved.

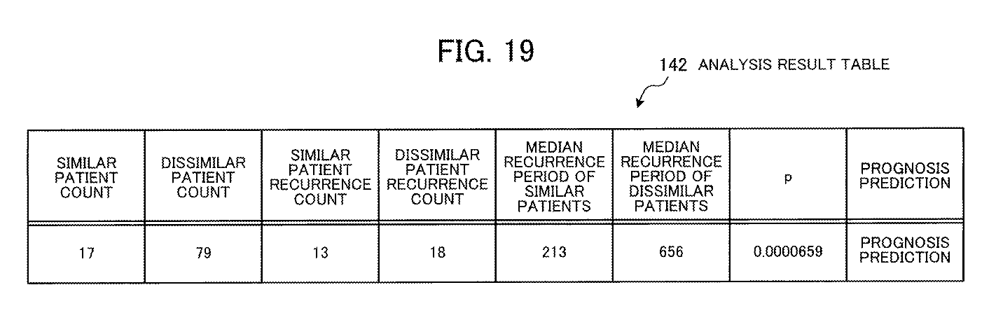

Next described is an example of the prognosis prediction in step S44 of FIG. 17. FIG. 19 illustrates an example of data calculated in step S44. An analysis result table 142 of FIG. 19 is data calculated by the patient information analyzing unit 140 in step S44, collectively expressed in table form. In the analysis result table 142, a column titled “similar patient count” presents the number of identified similar patients; a column titled “dissimilar patient count” presents the number of dissimilar patients other than the similar patients; a column titled “similar patient recurrence count” presents the number of patients having “1” in the item “recurrence” (indicating that the patient has experienced a recurrence) amongst the similar patients; and a column titled “dissimilar patient recurrence count” presents the number of patients having “1” in the item “recurrence” (indicating that the patient has experienced a recurrence) amongst the dissimilar patients.

A column titled “median recurrence period of similar patients” presents a value of the recurrence-free period at a point where the curve 141a of FIG. 18 crosses a line 141c indicating a recurrence-free rate of “0.5”. That is, the “median recurrence period of similar patients” indicates the time period over which 50% of the similar patients having “1” in the item “recurrence” experience a recurrence after the start of treatment. A column titled “median recurrence period of dissimilar patients” presents a value of the recurrence-free period at a point where the curve 141b of FIG. 18 crosses the line 141c. That is, the “median recurrence period of dissimilar patients” indicates the time period over which 50% of the dissimilar patients having “1” in the item “recurrence” experience a recurrence after the start of treatment. Note that a proportion of “0.5 (50%)” above may be set to any given value. For example, the time period over which a proportion m1 (0<m1<1) of the similar patients having “1” in the item “recurrence” experience a recurrence after the start of treatment is calculated as a value of the recurrence-free period at a point where the curve 141a of FIG. 18 crosses a line indicating a recurrence-free rate of “1−m1”.

A column titled “p-value” presents a p-value obtained by comparing a data group based on which the curve 141a in the clinical condition progression graph 141 of FIG. 18 is created with a data group based on which the curve 141b is created. That is, each of these data groups includes values of recurrence-free rates at individual discrete time points when the recurrence-free period begins at the start of treatment. The “p-value” is an index indicating the degree of association between the data groups, and the lower the p-value is, the higher the probability that there is association (significance) between the data groups. To calculate the p-value, one of the following tests may be employed, for example: generalized Wilcoxon test; Cox-Mantel test; and log-rank test.

Based on the data described above, the patient information analyzing unit 140 predicts the prognosis in step S44 according to, for example, the following criteria for determination.
If “p≦threshold (e.g., 0.05)” and “the median recurrence period of similar patients≦the median recurrence period of dissimilar patients”, the prognosis is poor.
If “p≦threshold” and “the median recurrence period of similar patients>the median recurrence period of dissimilar patients”, the prognosis is good.
If “p>threshold”, the prognosis is unknown.

Note that the criteria for determination may use the time period over which the above-described proportion m1 of the similar patients having “1” in the item “recurrence” experience a recurrence after the start of treatment, instead of the median recurrence period.

As described above, data entries registered under predetermined items are classified into similar patients and dissimilar patients so that a data group to be compared to a data group of the similar patients is created. This allows determination of whether the progress of medical conditions of the similar patients is good. As a result, the patient information analyzing unit 140 is able to calculate an index for predicting the prognosis of the designated patient whose patient information record resembles those of the similar patients. Herewith, the user is provided with useful determination results for supporting medical treatment of the designated patient.

In addition, the similar patients are retrieved using only the designated item named by the user and relevant items having strong relationships with the designated item as comparison targets, and are therefore likely to serve the user's purpose of searching. The prognosis prediction is made based on such search results, which enhances the accuracy of the prognosis.

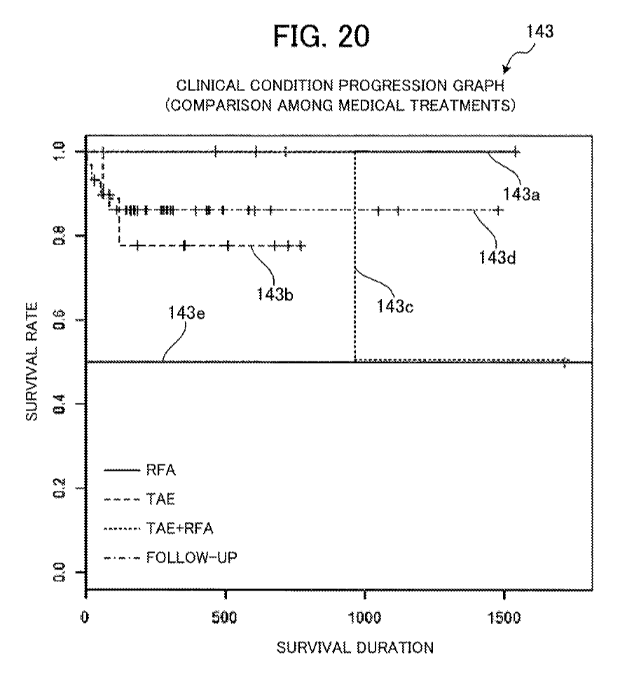

FIG. 20 illustrates an example of a clinical condition progression graph created in step S48. A clinical condition progression graph 143 of FIG. 20 represents an example where the time information item “survival duration” has been selected (in step S41). In this case, the horizontal axis represents the survival duration, and the vertical axis represents, for example, the survival rate. Such a clinical condition progression graph is created also when the item “termination in death” or “survival duration” has been named as the designated item. In addition, the vertical axis of the clinical condition progression graph 143 may represent the mortality rate instead.

While FIG. 18 above illustrates, as an example, the clinical condition progression graph 141 plotting recurrence-free period against recurrence-free rate, FIG. 20 illustrates, as an example, the clinical condition progression graph 143 plotting survival duration against survival rate. However, in actual processing, clinical condition progression graphs of the same type are created in steps S43 and S48 of FIG. 17. That is, if a clinical condition progression graph plotting recurrence-free period against recurrence-free rate is created in step S43, a clinical condition progression graph plotting recurrence-free period against recurrence-free rate is also created in step S48. In like fashion, if a clinical condition progression graph plotting survival duration against survival rate is created in step S43, a clinical condition progression graph plotting survival duration against survival rate is also created in step S48.

In the clinical condition progression graph 143 of FIG. 20, curves each representing state transition changes associated with one of four groups are plotted as Kaplan-Meier curves, for example. The four data groups are formed by classifying data entries registered under the individual items “termination in death” and “survival duration”, associated with similar patients. A first data group is a group of data entries registered under the items “termination in death” and “survival duration”, associated with similar patients having “1” in the item “RFA” (indicating that the patient has undergone RFA), and a curve 143a is created based on the first data group. A second data group is a group of data entries registered under the items “termination in death” and “survival duration”, associated with similar patients having “1” in the item “TAE” (indicating that the patient has undergone TAE), and a curve 143b is created based on the second data group. A third data group is a group of data entries registered under the items “termination in death” and “survival duration”, associated with similar patients having “1” in both the items “RFA” and “TAE”, and a curve 143c is created based on the third data group. Note that the first data group may omit data entries associated with similar patients having “1” in the item “TAE”. In this case, the second data group does not include data entries associated with similar patients having “1” in the item “RFA”.

A fourth data group is a group of data entries registered under items “termination in death” and “survival duration”, associated with similar patients having “0” in both the items “TAE” and “RFA” (indicating that the patients have undergone neither TAE nor RFA), and a curve 143d is created based on the fourth data group. Note that the term “follow-up” in FIG. 20 corresponds to the fourth group associated with the corresponding similar patients who have undergone neither TAE nor RFA.

Each of the curves 143a to 143d is created in the following manner, using the corresponding data group. The patient information analyzing unit 140 finds, amongst the similar patients belonging to the data group, the number of similar patients being alive at a given time when the survival duration begins at the start of treatment (the “starting point”). The number of similar patients being alive at the given time is obtained by adding together the number of similar patients having “0” in the item “termination in death” (indicating that the patient is alive) and the number of similar patients having “1” in the item “termination in death” (indicating that the patient is dead) but the time registered in the item “survival duration” being longer than the time period from the starting point to the given time. The patient information analyzing unit 140 calculates the survival rate at the given time by dividing the number of similar patients being alive obtained above by the total number of similar patients belonging to the data group. The patient information analyzing unit 140 performs this calculation for each indicated time point to thereby create each curve representing state transition changes associated with the corresponding data group, as illustrated in FIG. 20.

According to the clinical condition progression graph 143 of FIG. 20, the curves 143a to 143c each specific to an administered medical treatment are plotted on the same graph. This allows the user to easily determine, for each of the medical treatments, whether the progress of medical conditions is good. Then, the user is able to make use of such determination results in medical treatment of the designated patient whose patient information record resembles those of the similar patients. Further, the curve 143d associated with the similar patients having undergone no medical treatment is also plotted on the same graph, which allows the user to determine whether the administered medical treatments are effective.

In addition, the similar patients are retrieved using only the designated item named by the user and relevant items having strong relationships with the designated item as comparison targets, and are therefore likely to serve the user's purpose of searching. The clinical condition progression graph 143 is created based on such search results, which enhances usability of the clinical condition progression graph 143 for supporting medical treatment of the designated patient. For example, the user's determination accuracy based on the clinical condition progression graph 143 is improved.

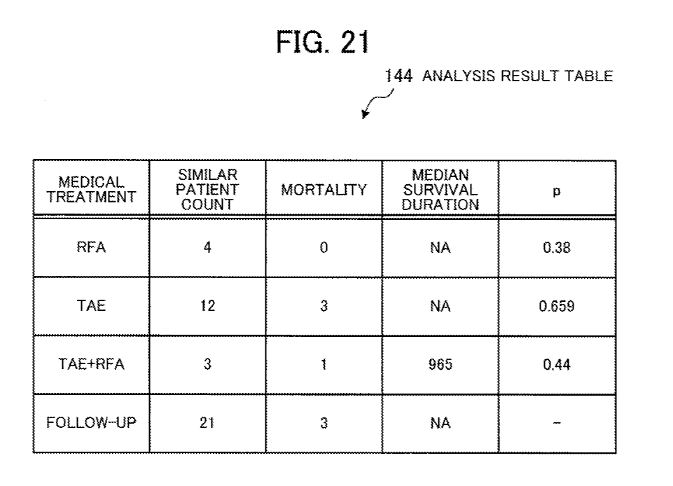

Next described is an example of the optimal medical treatment estimation in step S49 of FIG. 17. FIG. 21 illustrates an example of data calculated in step S49. An analysis result table 144 of FIG. 21 is data calculated by the patient information analyzing unit 140 in step S49, collectively expressed in table form. Records in the individual rows of the analysis result table 144 correspond one-to-one to the four data groups illustrated in FIG. 20. For example, the first record from the top of the analysis result table 144 corresponds to the first data group including a group of data entries associated with similar patients having undergone RFA. The second record corresponds to the second data group including a group of data entries associated with similar patients having undergone TAE. The third record corresponds to the third data group including a group of data entries associated with similar patients having undergone both TAE and RFA. The fourth record corresponds to the fourth data group including a group of data entries associated with similar patients having undergone neither TAE nor RFA.

Each entry under a column titled “medical treatment” in the analysis result table 144 indicates a medical treatment administered to the similar patients of the corresponding data group. In addition, each entry under a column titled “similar patient count” indicates the number of similar patients whose registered data entries belong to the corresponding record. Each entry under a column titled “mortality” indicates the number of patients who have already died amongst similar patients whose registered data entries belong to the corresponding record. This number of patients is the number of patients having “1” in the item “termination in death” amongst the similar patients whose registered data entries belong to the corresponding record.

Each entry under a column titled “median survival duration” indicates a value of the survival duration at a point where the curve of FIG. 20, associated with the corresponding record of FIG. 21, crosses a line 143e indicating a survival rate of “0.5”. That is, the “median survival duration” indicates the time period over which 50% of the similar patients whose registered data entries belong to the corresponding record progressed to death since the start of treatment. Note that a proportion of “0.5 (50%)” above may be set to any given value. For example, the time period over which a proportion m2 (0<m2<1) of the similar patients whose registered data entries belong to the corresponding record progressed to death since the start of treatment is calculated as a value of the survival duration at a point where the corresponding curve of FIG. 20 crosses a line indicating a survival rate of “1−m2”.

Entries under a column titled “p-value” are obtained by comparing the data groups based on which the individual curves 143a to 143c in the clinical condition progression graph 143 of FIG. 20 are created against the data group based on which the curve 143d is created. For example, a p-value associated with “RFA” is obtained by comparing the data group based on which the curve 143a is created against the data group based on which the curve 143d is created. Each of these data groups includes values of survival rates at individual discrete time points when the survival duration begins at the start of treatment. The “p-value” is an index indicating the degree of association between the compared data groups, and the lower the p-value is, the higher the probability that there is association (significance) between the data groups. To calculate the p-value, one of the following tests may be employed, for example: generalized Wilcoxon test; Cox-Mantel test; and log-rank test.

Based on the data described above, in step S49, the patient information analyzing unit 140 estimates an optimal medical treatment amongst the three types of medical treatments, i.e., RFA, TAE, and both RFA and TAE, based on the median survival durations and p-values associated with the individual medical treatments. For example, the patient information analyzing unit 140 estimates that, amongst the three types of medical treatments above, a medical treatment with the longest median survival duration and the smallest p-value is the optimal medical treatment. If a medical treatment with the longest median survival duration is different from a medical treatment with the smallest p-value, the patient information analyzing unit 140 estimates that, for example, a medical treatment with the longest median survival duration amongst medical treatments whose p-values are equal to or more than a predetermined threshold is the optimal medical treatment.

Note that, in the clinical condition progression graph 143 illustrated in FIG. 20, the individual curves 143a, 143b, and 143d do not cross the line 143e. Therefore, in FIG. 21, “N/A (not available)” is entered, within each of the records corresponding to the curves 143a, 143b, and 143d, under the column titled “median survival duration”. In addition, the above-described estimation process may use the time period over which the above-described proportion m2 of the similar patients whose registered data entries belong to the corresponding record progressed to death since the start of treatment, instead of the median survival duration.

As described above, data entries registered under predetermined items, associated with similar patients are classified according to individual medical treatments, and indexes indicating how good the prognosis is, such as a median survival duration and p-value, are calculated for each classified data group. This allows a medical treatment with the best prognosis to be estimated amongst medical treatments administered to similar patients in the past so that the estimated medical treatment is output as an optimal medical treatment to be administered to the designated patient. Herewith, the user is provided with useful determination results for supporting medical treatment of the designated patient.

In addition, the similar patients are retrieved using only the designated item named by the user and relevant items having strong relationships with the designated item as comparison targets, and are therefore likely to serve the user's purpose of searching. The optimal medical treatment is estimated based on such search results, which improve the accuracy of estimation. According to the above-described processing of the server 100, it is possible to eventually provide the user with useful information and determination results for medical treatment of the designated patient named by the user.

For example, at least one of items referenced to create the clinical condition progression graphs 141 and 143 is the designated item named by the user to identify relevant items, and the other referenced items are closely associated with the designated item. Further, similar patients are retrieved using only the designated item named by the user and the relevant items having strong relationships with the designated item as comparison targets, and are therefore likely to serve the user's purpose of searching. Then, based on such search results, the clinical condition progression graphs 141 and 143 are created. As a result, the clinical condition progression graphs 141 and 143 are likely to represent accurate content that suits the user's purpose of searching. Therefore, determination results based on such clinical condition progression graphs 141 and 143 are less likely to include false positives and negatives.

This in turn enhances the usability of the clinical condition progression graphs 141 and 143 to support medical treatment of the designated patient. For example, the accuracy of the prognosis prediction of the designated patient based on the clinical condition progression graph 141 is enhanced. In addition, the accuracy of estimation of an optimal medical treatment based on the clinical condition progression graph 143 is enhanced.

Note that the second embodiment above illustrates an example where the server 100 creates the clinical condition progression graphs 141 and 143. However, for example, in the case where a plurality of test result values and step values, such as the ones for the item “stage”, are registered in the patient database 111 in chronological order, the server 100 may classify such data into similar patients and dissimilar patients, and plot the time series variation of each data group on the same graph. In addition, the server 100 may classify such chronological data associated with the similar patients according to individual medical treatments, and plot the time series variation of each data group on the same graph.

Note that the processing functions of each of the apparatuses (for example, the information analysis device 10 and the server 100) described in the embodiments above may be achieved by a computer. In this case, a program is made available in which processing details of the functions to be provided to each of the above-described apparatuses are described. By executing the program on the computer, the above-described processing functions are achieved on the computer. The program in which processing details are described may be recorded in a computer-readable recording medium. Such computer-readable recording media include a magnetic-storage device, an optical disk, a magneto-optical recording medium, and a semiconductor memory. Examples of the magnetic-storage device are a hard disk drive (HDD), a flexible disk (FD), and a magnetic tape. Example of the optical disk are a digital versatile disc (DVD), a DVD-RAM, a compact disc-read only memory (CD-ROM), a CD-recordable (CD-R), and a CD-rewritable (CD-RW). An example of the magneto-optical recording medium is a magneto-optical disk (MO).

In the case of distributing the program, for example, portable recording media, such as DVDs and CD-ROMs, in which the program is recorded are sold. In addition, the program may be stored in a storage device of a server computer and then transferred from the server computer to another computer via a network.

A computer for executing the program stores the program, which is originally recorded in a portable storage medium or transferred from the server computer, in its own storage device. Subsequently, the computer reads the program from the storage device and performs processing according to the program. Note that the computer is able to read the program directly from the portable storage medium and perform processing according to the program. In addition, the computer is able to sequentially perform processing according to a received program each time such a program is transferred from the server computer connected via a network.

According to one aspect, it is possible to provide useful information for decision making on a course of treatment for a patient.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable storage medium storing a computer program that causes a computer to perform a procedure comprising:
identifying, amongst a plurality of patient information records corresponding one-to-one to a plurality of patients and stored in a memory, one or more second patient information records each resembling a first patient information record corresponding to a particular patient; and
outputting, based on the plurality of patient information records, a first plotted line representing medical condition changes over time in a first patient group that corresponds to the second patient information records and a second plotted line representing the medical condition changes over time in a second patient group that corresponds to remaining patient information records, the remaining patient information records being the plurality of patient information records other than the second patient information records.

2. The non-transitory computer-readable storage medium according to claim 1, wherein:
each of the first plotted line and the second plotted line is created based on, amongst data entries included in the plurality of patient information records, data entries each indicating an amount of time taken for a patient in the corresponding patient group to enter a particular state following start of treatment, and represents changes over time in proportion of patients having, or having not, entered the particular state to a total number of patients in the corresponding patient group.

3. The non-transitory computer-readable storage medium according to claim 2, wherein:
the procedure further includes:
calculating an index indicating significance of differences between a first data group corresponding to the first plotted line and a second data group corresponding to the second plotted line; and
outputting, based on the index, prediction information indicating whether prognosis of the particular patient is good.

4. The non-transitory computer-readable storage medium according to claim 3, wherein:
the procedure further includes:
classifying, based on the plurality of patient information records, the patients individually corresponding to the plurality of patient information records into a plurality of patient groups according to treatment modalities when the prediction information indicates that the prognosis is not good; and
outputting, based on the plurality of patient information records, a plurality of plotted lines each representing the medical condition changes over time in one of the classified patient groups.

5. The non-transitory computer-readable storage medium according to claim 1, wherein:
each of the plurality of patient information records registers data entries under a plurality of items, and
the identifying the second patient information records includes identifying, as the second patient information records, patient information records whose data entries registered under a particular item amongst the plurality of items resemble a data entry registered in the first patient information record under the particular item.

6. The non-transitory computer-readable storage medium according to claim 5, wherein:
the procedure further includes identifying, based on item mapping information where, amongst the plurality of items, each of items selectable as a designated item is mapped to, amongst the plurality of items, a different item whose registered data entries have relationships with the data entries registered under the item, a second item having relationships with a first item selected as the designated item, and
the identifying the second patient information records includes identifying, as the second patient information records, patient information records whose data entries registered under the second item, or data entries registered under the first item and the second item, resemble a data entry registered under the second item, or data entries registered under the first item and the second item, in the first patient information record.

7. The non-transitory computer-readable storage medium according to claim 6, wherein:
the first plotted line and the second plotted line are created based on, amongst the data entries included in the plurality of patient information records, data entries registered under at least the first item.

8. An information analysis method comprising:
identifying, by a computer, amongst a plurality of patient information records corresponding one-to-one to a plurality of patients and stored in a memory, one or more second patient information records each resembling a first patient information record corresponding to a particular patient; and
outputting, by the computer, based on the plurality of patient information records, a first plotted line representing medical condition changes over time in a first patient group that corresponds to the second patient information records and a second plotted line representing the medical condition changes over time in a second patient group that corresponds to remaining patient information records, the remaining patient information records being the plurality of patient information records other than the second patient information records.

9. An information analysis apparatus comprising:
a processor configured to perform a procedure including:
identifying, amongst a plurality of patient information records corresponding one-to-one to a plurality of patients and stored in a memory, one or more second patient information records each resembling a first patient information record corresponding to a particular patient, and
outputting, based on the plurality of patient information records, a first plotted line representing medical condition changes over time in a first patient group that corresponds to the second patient information records and a second plotted line representing the medical condition changes over time in a second patient group that corresponds to remaining patient information records, the remaining patient information records being the plurality of patient information records other than the second patient information records.
